(19) United States
(12) Patent Application Publication
(10) Pub. No.: US 2013/0226612 A1
(43) Pub. Date: Aug. 29, 2013

(54) FRAMEWORK FOR EVIDENCE BASED CASE STRUCTURING

(71) Applicants: Boaz Carmeli, Koranit (IL); Carmel Kent, Zippori (IL); Yonatan Maman, Hof Hacarmel (IL); Ruth Rinott, Jerusalem (IL); Yoav Rubin, Haifa (IL); Noam Slonim, Jerusalem (IL)

(72) Inventors: Boaz Carmeli, Koranit (IL); Carmel Kent, Zippori (IL); Yonatan Maman, Hof Hacarmel (IL); Ruth Rinott, Jerusalem (IL); Yoav Rubin, Haifa (IL); Noam Slonim, Jerusalem (IL)

(73) Assignee: International Business Machines Corporation, Armonk, NY (US)

(21) Appl. No.: 13/366,325

(22) Filed: Feb. 26, 2012

(51) Int. Cl. G06Q 50/22; G06Q 50/24

(52) U.S. Cl. 705/3; 705/2

(57) ABSTRACT

A computerized method of generating evidence based case object for a decision support application. The method comprises providing a medical decision point, generating a decision point model mapping between a plurality of patient dependent clinical characteristics and a plurality of treatment options for the medical decision point according to a plurality of guidelines, estimating, using a processor, a plurality of treatment outcomes for each the treatment option, each the treatment outcome being estimated according to an analysis of medical records of a group of patients been at the medical decision point and having a subset of the plurality of patient dependent clinical characteristics selected from a plurality of subsets, and generating evidence based case object which receive patient data having patient dependent clinical characteristics matching one of the plurality of subsets and outputs an estimated prognosis based on a respective treatment outcome from the plurality of treatment outcomes.

### BACKGROUND

The present invention, in some embodiments thereof, relates to evidence based medical systems and methods and, more specifically, but not exclusively, to platforms and methods of generating evidence based case objects.

Evidence based medicine (EBM), also known as evidence-based practice (EBP), is best described as explicit, judicious and conscientious consideration of current best evidence from research in making decisions about the care of individual patients. The practice of evidence based medicine means integrating individual clinical expertise with best available external clinical evidence from systematic research”. EBM is based on the idea that current valid evidence should be used to support clinical decisions.

Case Based Reasoning (CBR) is the process of solving new problems based on the solutions of similar past problems. CBR is a decision strategy used by physicians when trying to induce a clinical decision based on their and their colleagues past experience. State-of-the-art CBR systems rely on electronic health records (EHRs) of patients as the case base, using various data mining techniques to identify and extract a number of similar cases to the case at hand, in order to give the physician an automated CBR abilities.

### SUMMARY

According to some embodiments of the present invention, there is provided a computerized method of generating evidence based case object for a decision support application. The method includes providing a medical decision point, generating a decision point model mapping between a plurality of patient dependent clinical characteristics and a plurality of treatment options for the medical decision point according to a plurality of guidelines for the medical decision point, estimating, using a processor, a plurality of treatment outcomes for each the treatment option, each the treatment outcome being estimated according to an analysis of medical records of a group of patients been at the medical decision point and having a subset of the plurality of patient dependent clinical characteristics from a plurality of subsets, and generating evidence based case object which receive patient data having patient dependent clinical characteristics matching one of the plurality of subsets and outputs an estimated prognosis for the patient at the medical decision point based on a respective treatment outcome from the plurality of treatment outcomes.

According to some embodiments of the present invention, there is provided a computer program product for generating evidence based case object for a decision support application. The computer program product includes a computer readable storage medium, first program instructions to provide a medical decision point, second program instructions to generate a decision point model mapping between a plurality of patient dependent clinical characteristics and a plurality of treatment options for the medical decision point according to a plurality of guidelines extracted from at least one medical knowledge database, third program instructions to generate a decision point model mapping between a plurality of patient dependent clinical characteristics and a plurality of treatment options for the medical decision point according to a plurality of guidelines extracted from at least one medical knowledge database, and fourth program instructions to estimate a plurality of treatment outcomes for each the treatment option, each the treatment outcome being estimated according to an analysis of medical records of a group of patients been at the medical decision point and having a subset of the plurality of patient dependent clinical characteristics selected from a plurality of subsets, and fifth program instructions to generate an evidence based case object which receive patient data having patient dependent clinical characteristics matching one of the plurality of subsets and outputs an estimated prognosis for the patient at the medical decision point based on a respective treatment outcome from the plurality of treatment outcomes.

The first, second, third and fourth program instructions are stored on the computer readable storage medium.

According to some embodiments of the present invention, there is provided evidence based case object for a decision support application. The evidence based case object comprises an input interface which receives a set of patient dependent clinical characteristics of a certain patient selected from a plurality of patient dependent clinical characteristics, a decision point model mapping between the plurality of patient dependent clinical characteristics and a plurality of treatment options for a medical decision point, each the treatment option being associated with at least one estimated outcome for a patient having a subset of the plurality of patient dependent clinical characteristics, and an output interface which outputs an estimated prognosis for the patient at the medical decision point based on respective the decision point model.

According to some embodiments of the present invention, there is provided a system of generating evidence based case object for a decision support application. The system comprises a processor, an interface which receives a medical decision point, a mapping module which generates a decision point model mapping between a plurality of patient dependent clinical characteristics and a plurality of treatment options for the medical decision point according to guidelines extracted from at least one medical knowledge database, and an output module which generates an evidence based case object which receive patient data having a subset of the patient dependent clinical characteristics and outputs an estimated prognosis for the patient at the medical decision point. The mapping module estimates, using a processor, a plurality of treatment outcomes for each the treatment option, each the treatment outcome being estimated according to an analysis of medical records of a group of patients been at the medical decision point and having a subset of the plurality of patient dependent clinical characteristics selected from a plurality of subsets. The output module generates the evidence based case based on respective of the plurality of treatment outcomes.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of generating evidence based case object for a certain medical decision point from medical knowledge and medical records databases, according to some embodiments of the present invention;

FIG. 2 is a schematic illustration of a platform of generating evidence based case objects, for example according to the methodology depicted in FIG. 1, according to some embodiments of the present invention;

FIG. 3A is a graph demonstrating an exemplary declarative decision point model for an adjuvant breast cancer decision point, according to some embodiments of the present invention;

FIG. 3B is a graph demonstrating a set of patient dependent clinical characteristics and the relations therebetween, according to some embodiments of the present invention;

FIG. 3C is a schematic illustration of a procedural rule that is part of a procedural decision point model, according to some embodiments of the present invention;

FIGS. 4A-4B are screenshots of a user interface depicting assessment of treatment options and related outcomes of certain group of patients selected according to patient similarity, according to some embodiments of the present invention;

FIG. 4C is graph comparing predictive results for each one of the above treatment options based on their outcomes, according to some embodiments of the present invention;

FIG. 5 is a snapshot of an exemplary report produced by an exemplary object, according to some embodiments of the present invention; and

FIGS. 6A-6C are set of images depicting a domain expert user interface (A), a data integration user interface (B), and an analytics user interface (C), according to some embodiments of the present invention.

### DETAILED DESCRIPTION

The present invention, in some embodiments thereof, relates to evidence based medical systems and methods and, more specifically, but not exclusively, to platforms and methods of generating evidence based case objects.

According to some embodiments of the present invention, there are provided methods and systems of generating evidence based case objects for a certain decision point. The evidence based case objects are set with a decision point model mapping between a plurality of patient dependent clinical characteristics and a plurality of treatment options for the medical decision point based on data extracted from a plurality of guidelines and medical records of patients which are or have been at the certain decision point. The model is optionally enforced with statistical data pertaining to patient groups and having certain patient dependent clinical characteristics and/or estimated treatment outcomes for a patient having these certain patient dependent clinical characteristics. The treatment outcomes may be estimated according to analysis of medical records of patients that had been in that decision point, selected from medical records databases and for which clinical outcome is recorded in that database.

The methods and systems allow generating an evidence based object that provides a prognosis to a patient at a certain medical decision point using a model generated by integrating clinical evidences of patients having similar clinical characteristics, which are selected according to guidelines designated for the certain medical decision point. In such a manner, the object provides a personalized clinical decision support to treat a specific impairment of health for patients having different genetic and/or clinical profiles without information overload involved in decision support based on data from multiple medical records databases.

Optionally, the object uses set of algorithms for identifying patient groups and for outcome prediction generated using machine learning algorithms data aggregators, weighted predictions, and/or expert inputs.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

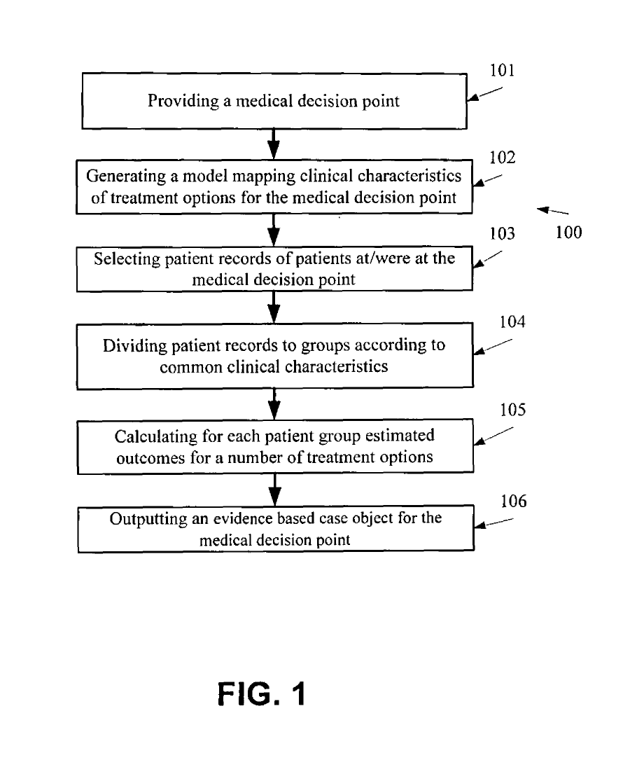

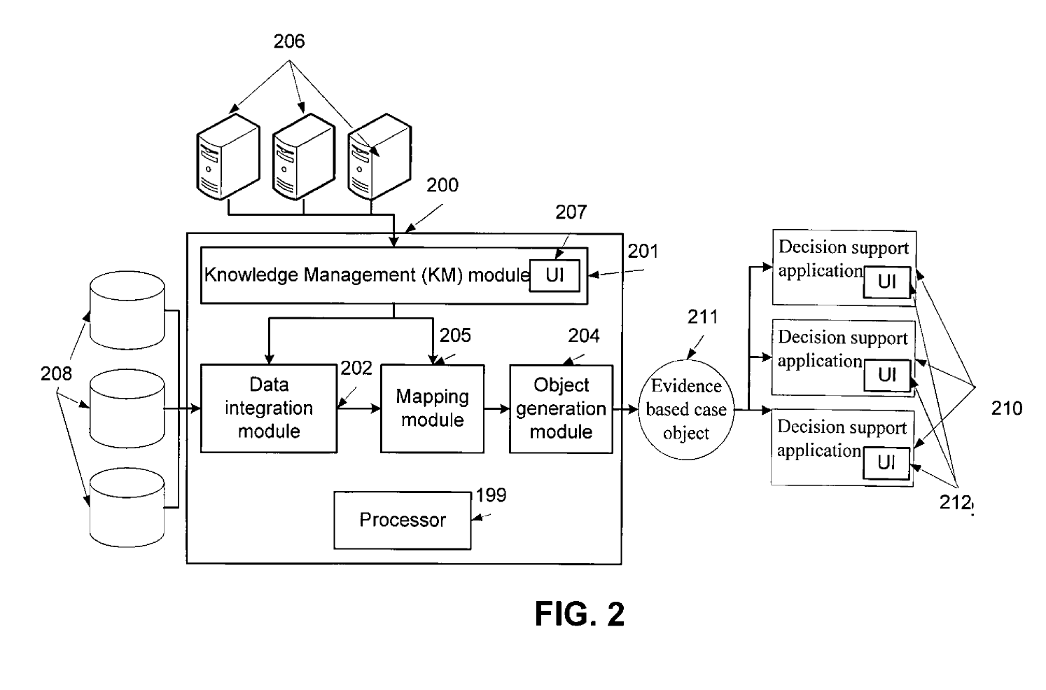

Reference is now made to FIG. 1, which is a flowchart 100 of a method 100 of generating evidence based case object(s) for a decision support application(s), based on data gathered for a certain medical decision point from medical guidelines, documented and/or manually inputted, and medical records databases, according to some embodiments of the present invention. Reference is also made to FIG. 2, which is a schematic illustration of a platform 200 of generating evidence based case object(s) 211, for example according to the methodology depicted in FIG. 1, according to some embodiments of the present invention. Optionally, the evidence based case object 211 is adapted to a unified application program interface (API) for clinical decision support for medical decision points pertaining to treating different types of diseases for different genetic and/or clinical profiles based on the integrated data and provided algorithms. Optionally, the method 100 and system 200 allow an operator to control the distribution of the evidence based case objects 211. Optionally, customers who use the evidence based case objects 211 may be charged by various models, for example, pay per use, pay per object, and/or pay per object generation request. Optionally, evidence based case objects 211 may be used as a trade currency where one operator trades one evidence based case object 211 for another with another operator. The method 100 and system 200 allow care centers to share knowledge without giving access to their medical and/or knowledge records. In such a manner, privacy can be maintained (no medical records are outputted) and/or copyright is not infringed (e.g. proprietary guidelines). It should be note that a care center may use the evidence based case objects for marketing and branding as an efficient evidence based case object is indicative, inter alia, that good practices are documented in the medical records of the care center.

As further described below, the method 100 and platform 200, for example an object generation module 204 thereof, generates an evidence based case object 211 which provides a holistic, personalized, real time view to be used by a decision support tool, designated to a specific medical case and devoid of information overload involved in decision support based on data from multiple medical records databases. The evidence based case object 211 provides decision support that is based on clinical evidence(s) derived by advance deductive and inductive techniques applied to diverse clinical evidence resources. The evidence based case object 211 structurally encompasses information aspects needed to be taken into account by clinical decision maker(s), regarding a patient having a specific medical condition and set to be used by decision support application(s) 210, such as a guidelines adherence application, an outcomes assessment application and/or a cost optimization application by standard interfaces. The decision support applications 210 are optionally installed in a plurality of client terminals, such as personal computers, tablets, thin clients, Smartphones and/or the like. Optionally, each of the decision support applications 210 includes a user interface 212 that allows users to input patient dependent characteristics of a certain patient at the medical point decision for analysis and for receiving a respective prognosis, for example as described below. Optionally, each of the decision support applications 210 includes a user interface (not shown) that allows users to input a medical point decision for analysis. The evidence based case object 211 may be provided directly and/or via a communication network, such as the internet.

The platform 200 may be implemented as an independent platform, an add-on to existing platforms, and/or as a software as a service (SaaS) which provides services for users via client terminals.

As further described below, the method 100 and platform 200 integrates clinical evidences from medical records databases 208 together with guidelines pertaining to a certain clinical case while producing statistical results aggregators, weighted predictions, and/or treatment recommendations using data mining, machine learning and other statistical and rule based techniques.

First, as shown at 101, a medical decision point is identified and modeled, for example via a user interface 207, such as a graphical user interface (GUI), of a knowledge management (KM) module 201. The user interface 207 allows a user to provide inputs and/or make selections.

As used herein, a medical decision point is a single well-recognized point in a known care process of a particular impairment of health, such as a disease in which a physician need to take some action, e.g., prescribe a drug or perform a medical operation. Optionally, the medical decision point may be a medical decision in a care process orchestrated from a sequence of decision points.

A medical decision point may involve a certain degree of uncertainty. Optionally, a medical decision point is characterized by a range of a plurality of patient dependent characteristics, a range of a plurality of possible treatment options and a range of a plurality of possible clinical outcomes for each of the possible clinical treatments. For example, a medical decision point is selecting a systemic adjuvant treatment for breast cancer patients; see Loprinzi CL, Thome SD. Understanding the utility of adjuvant systemic therapy for primary breast cancer. Journal of Clinical Oncology 2001; 19(4):972. In this example, the patient dependent characteristics include clinical factors (age, pre/post menopause), pathology factors, family history, personal treatment history, commercially available genetic prognostic scores like Oncotype DX, and/or the like. The range of possible treatment options includes endocrine therapy, chemotherapy, targeted therapy, and/or luck of any therapy, and/or any combination thereof. The range of possible clinical outcomes in this example may be a recurrence free survival (RFS) for each treatment. Alternatively or additionally, outcomes definitions may include a combination of side effects, breast cancer-specific survival (BCSS), RFS, and/or the like.

Now, as shown at 102, a decision point model mapping between a plurality of patient dependent clinical characteristics and a plurality of treatment options for the medical decision point is generated according to guidelines extracted from one or more medical knowledge databases 206, for example by the KM module 201, optionally using processor 199. Each guideline for a certain treatment option is adapted to patients having certain patient dependent clinical characteristics. As used herein, patient dependent characteristics include demographic characteristics, such as age, gender, and occupation, physical characteristics, optionally phenotypic, such as height, weight, and body mass index BMI, pathologic characteristics, such as tumor size and location, pathology factors, family history, personal treatment history, commercially available genetic prognostic scores, and genotypic characteristics such as the presence or absence of certain genetic elements, for example estrogen, progesterone and deoxyribonucleic acid (DNA) sequences.

Optionally, the decision point model further maps statistical figures for a plurality of clinically identified outcomes of each one of the treatment options, for example average and distribution of success, failure, partial success (e.g. diminishing of a tumor size by a certain percentage, changing certain medical indexes and/or the like). Optionally, the decision point model may map side effects and other quality of life parameters to the plurality of clinically identified outcomes.

Optionally, the KM module 201 encapsulates clinical guidelines and evidences after interacting with respective medical knowledge databases, such as clusters of medical articles which describe guidelines of certain treatment options, treatment center database that includes treatment center guidelines, health authorities medical knowledge database that includes treatment guidelines, and/or the like.

According to some embodiments of the present invention, the KM module 201 generates the decision point model based on declarative and procedural data from the medical knowledge databases. The declarative and procedural data are used to create a decision point model that provides a comprehensive description of the decision point. Optionally, the declarative data is arranged in a hierarchical structure of patient dependent clinical characteristics, properties of patient dependent clinical characteristics, and relations therebetween. For example, the patient dependent clinical characteristic of tumor size is categorized as a property of a tumor and characterized by properties like aggressiveness and measurement units (e.g., millimeter). The procedural data includes guidelines defining how to operate upon these patient dependent clinical characteristics. Briefly stated declarative data is a “know-what” while a procedural knowledge is the “know-how”, see Nickols F. The knowledge in knowledge management. 2000; In Cortada J W, Woods J A. (Eds.) The knowledge management yearbook 2000-2001 Boston, Mass.: Butterworth-Heinemann, 12-21.

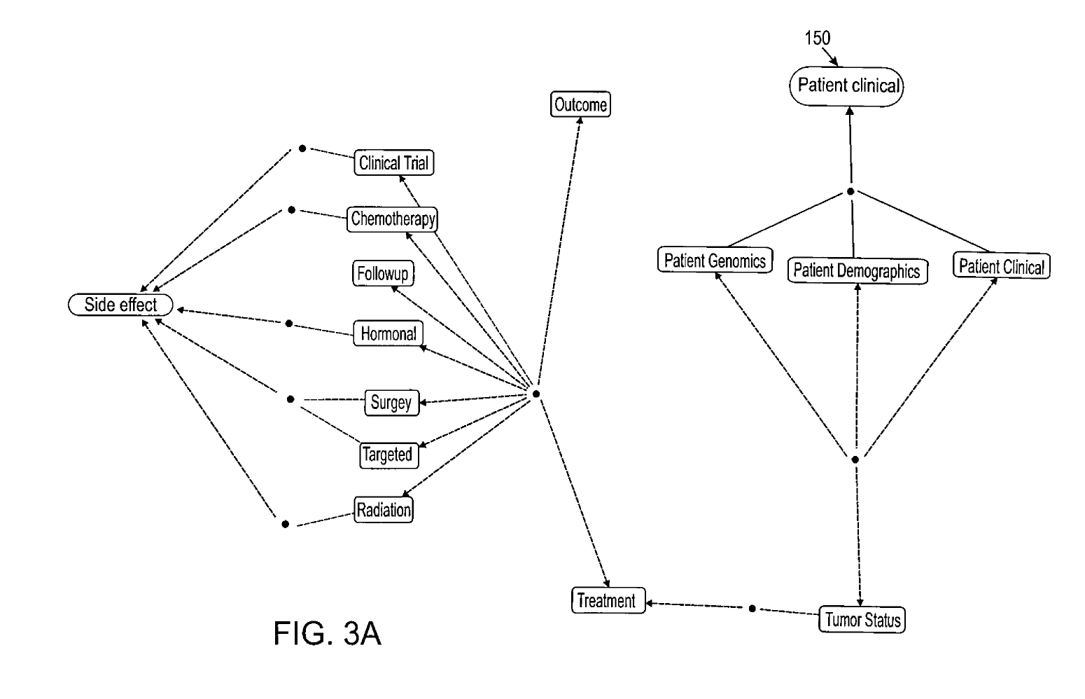

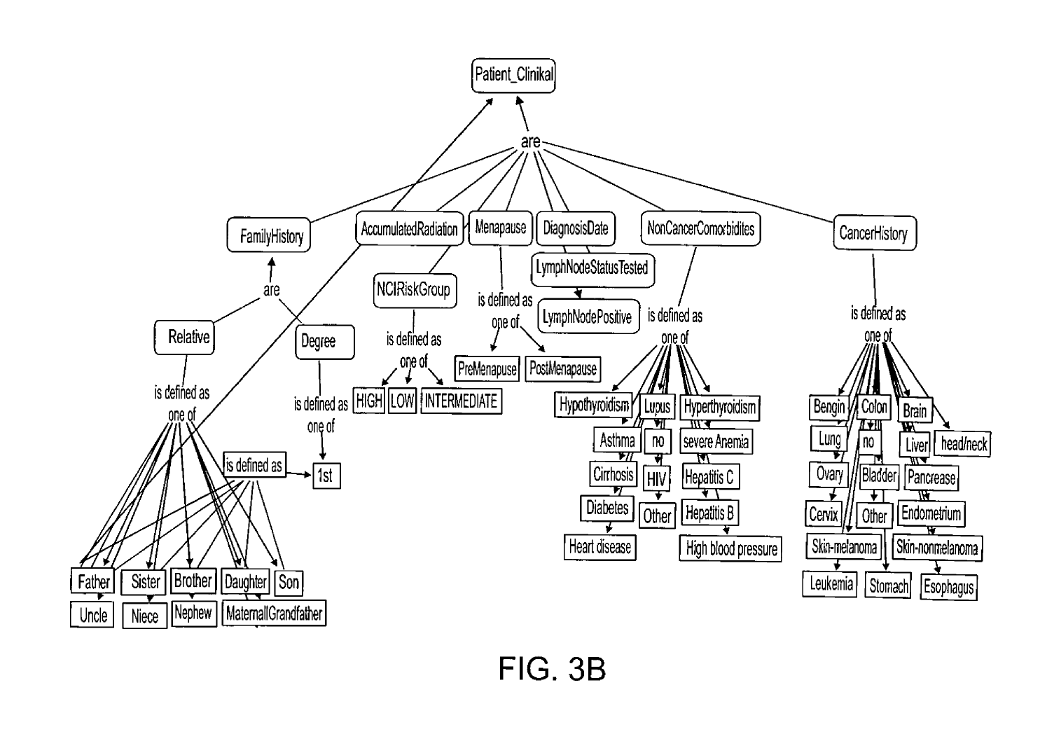

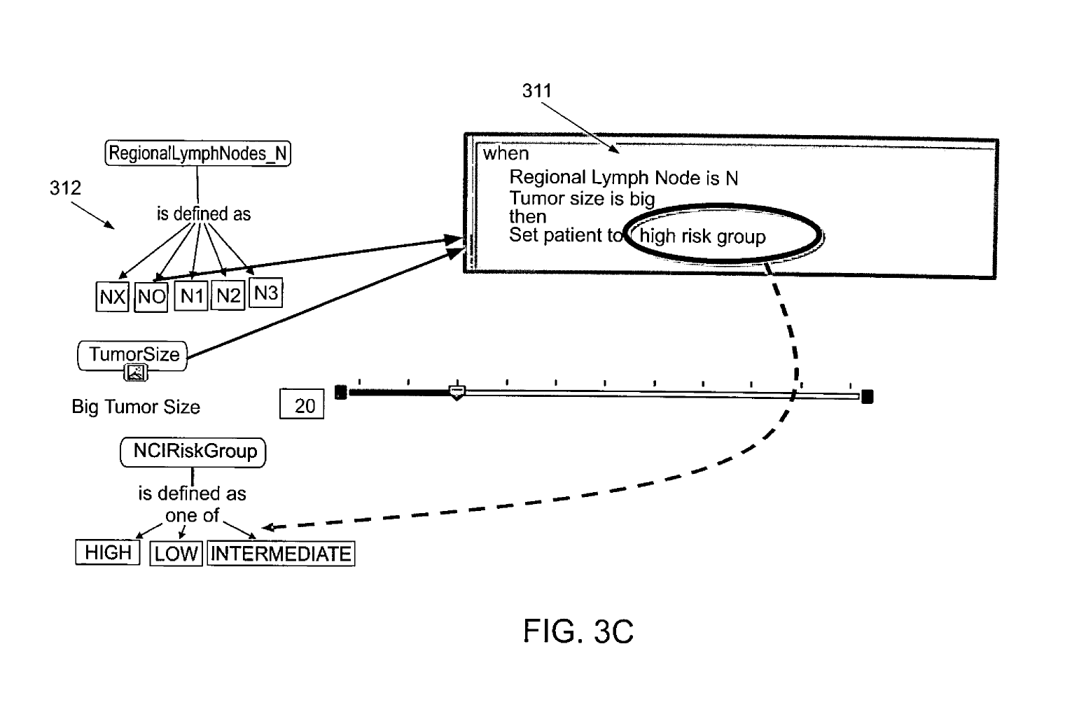

Optionally, the KM module 201 arranges the treatment options in a declarative decision point model, optionally hierarchical, for example by applying one or more ontologies, data learning rules and/or diffusion processes. The declarative decision point model may arrange the presented nodes according to core properties of the decision point. For example, World Wide Web consortium (W3C) web ontology language (OWL) is used to structure and form an explicit semantic representation of the plurality of treatment options associated with the decision point. Existing clinical terminologies, for example systematized nomenclature of medicine (SNOMED), and relevant industry standards (e.g., health level 7 (HL7) reference information model (RIM) are used to ease the formulation and re-usability of the decision point model. For example, FIG. 3A demonstrates an exemplary declarative decision point model for an adjuvant breast cancer decision point. Each of the nodes shows is a nested node, which comprise of a bunch of patient dependent clinical characteristics and relations, see for example FIG. 3B that depicts an expansion of a patient clinical node 150 of FIG. 3A). The nodes on the right side branch, which are related to patient genomics, patient demographics, patient clinical, and tumor status, refer to clinical characteristics of the patient. The range of possible treatment options is modeled by the nodes in the left side branches. Finally, the outcome and side effect nodes, which refer to clinical outcomes that are relevant to the decision point, are also present. The decision point model is optionally generated using a mapping module 205, such as the Florida Institute for human & machine cognition (IHMC) patient dependent clinical characteristic mapper.

Now, procedural data associated with the decision point, is arranged in a procedural decision point model, optionally according to a rule-based approach. Optionally, the procedural decision point model includes a set of procedural rules which are optionally provided in a natural scheme to determine how to represent relations among patient dependent clinical characteristics extracted from the procedural data and how to derive inferences based on the relations. The procedural rules, which are optionally domain-specific, are formulated, optionally automatically, based on the above declarative decision point model. For example, FIG. 3C depicts a schematic illustration of a procedural rule 311 that is part of the procedural decision point model. The procedural rule 311 is depicted in association with relevant nodes 312 in the declarative decision point model which are used for the generation thereon. The depicted rule is simplified for brevity purposes. The rule is written using domain specific language in Drools, a business rule management system (BRMS) with a forward chaining inference based rules engine, using an enhanced implementation of Rete algorithm.

Optionally, the procedural decision point model is combined with the declarative decision point model, for example by associating procedural rules with nodes of the declarative decision point model. In such embodiments, rules defined in the procedural decision point model are combined with one or more nodes defined in the declarative decision point model, for instance the nodes used for the formulation thereof.

As shown at 103, a plurality of patient records of a plurality of patients which have been at the medical decision point are selected from one or more medical records databases, such as EHR. Optionally, the medical records databases are accessed by a data integration module 202. Each one of these medical records describes patient dependent clinical characteristics of a certain patient, one or more treatment options taken for her at the medical decision point and one or more outcomes thereto. Optionally, these records are identified according to the above decision point model, for example according to a match between a branch in the hierarchical decision point model and terms extracted by semantic analysis of records. Rule based similarity classifiers may be used for identifying the records based on the decision point model.

As shown at 104, the patient records are now divided to a plurality of patient groups each includes patient records of patients having common and/or similar patient dependent clinical characteristics at the medical decision point. Optionally, machine learning techniques are used to suggest refined patient-similarity metrics, yielding fine-grained similar patient groups. Optionally, machine learning techniques are used to suggest patient groups other then those recommended by the model, based on retrospective analysis of physician decision and achieved outcome, yielding in knowledge and/or guideline refinements.

Now, as shown at 105, for each patient group, a plurality of estimated outcomes are calculated to some or all of the plurality of treatment options, optionally using processor 199. As used herein, an estimated outcome means an outcome calculated according to an analysis, optionally statistical, of respective patient records, for example by an analysis module 203. The estimated outcome may include and/or be a calculated predicted risk for a certain patient and/or a predicted treatment, for example which treatment will probably given (e.g. prescribed) to certain patients.

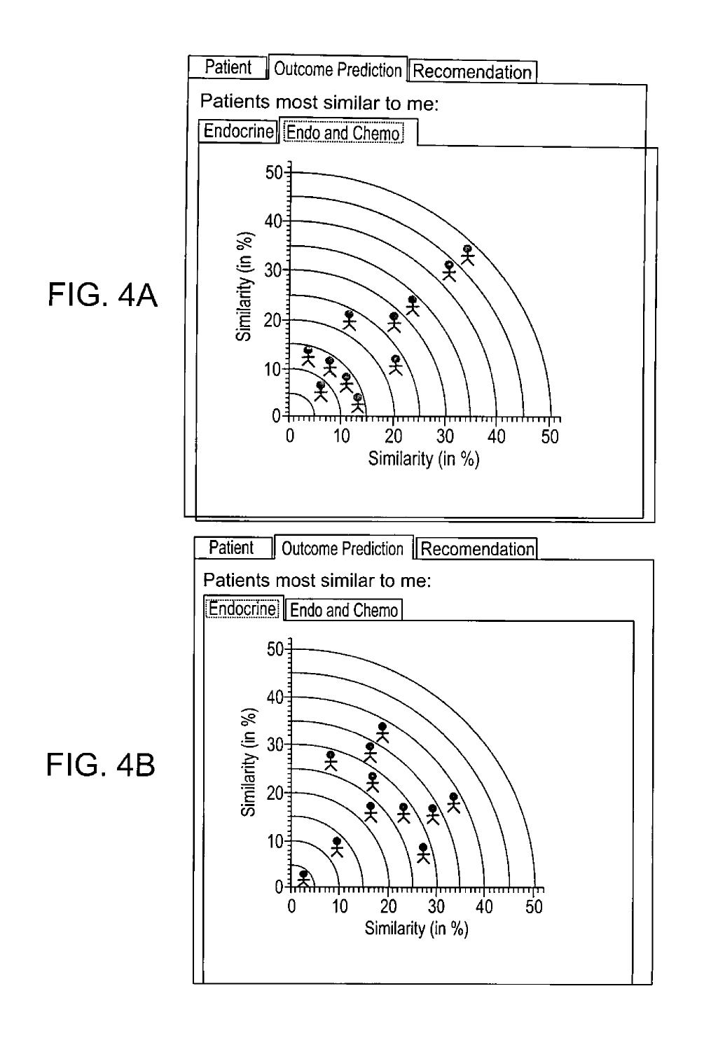

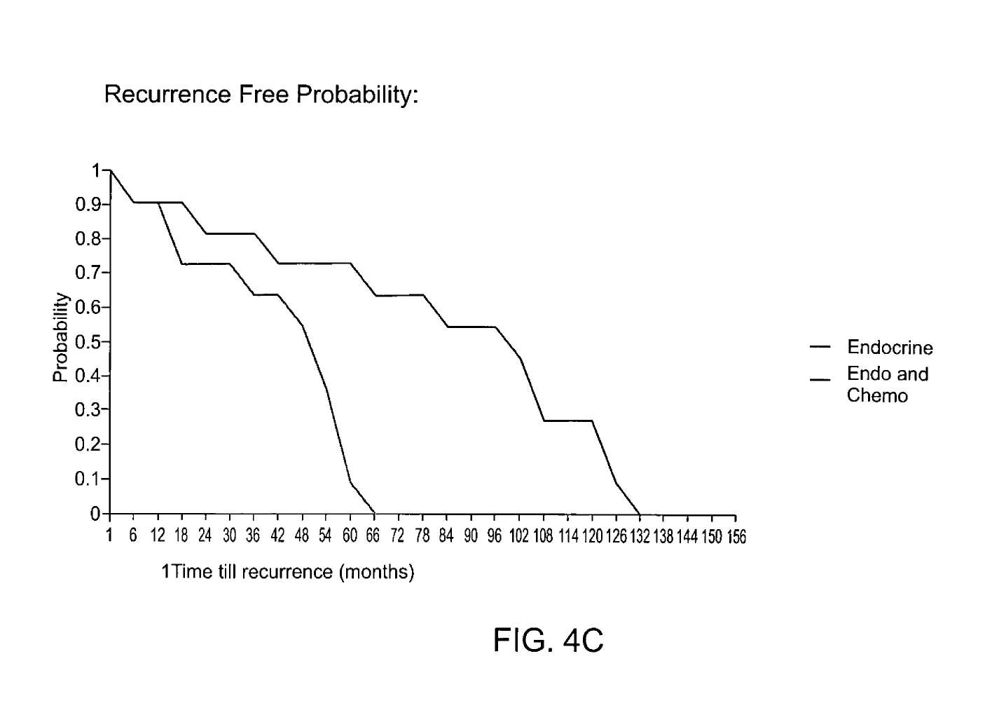

The outputs allow matching between a certain patient and outcome of a treatment given to a group of patients having similar patient dependent clinical characteristics. This allows indicating which treatment provided better results for patients having similar patient dependent clinical characteristics. For example, FIGS. 4A-4B depicts a number of screenshots of a user interface depicting assessment of treatment options and related outcomes of certain group of patients selected according to patient similarity. FIG. 4A depicts a group of similar patients that was treated with Endocrine therapy and Chemotherapy and FIG. 4B depicts a group of similar patients that was treated with Endocrine therapy. FIG. 4C is graph comparing predictive results for each one of the above treatment options based on their outcomes.

Clinical characteristics that best differentiate the above groups may be identified. Optionally, the outcomes are added to the decision point model, for example as evidence based data indicative of a success and/or failure rate of a certain treatment option given to a patient having certain clinical characteristics. As treatment guidelines may be received from a number of sources, the outcomes of the treatment patterns of different care centers and/or physicians may be documented in the decision point model so that each outcome may indicate the efficacy of a respective treatment pattern.

As the estimated outcomes are for a certain group of patients having common patient dependent clinical characteristics, they indicate which treatment pattern fit better to a patient having similar patient dependent clinical characteristics.

Optionally, relative contribution of each patient dependent clinical characteristic to the outcome is weighted. Optionally, based on this weighting, an alternative segmentation of the patients into patient groups is suggested and/or iteratively made using statistically-based similarity measures.

For example, for a certain medical decision point a decision point model maps a plurality of treatment options, extracted from NCI guidelines, which recommend an endocrine treatment and leaving chemotherapy for a physician's consideration. Using a retrospective analysis on an exemplary medical records database reveals a number of patient groups among them a group of patients who satisfy the following the patient dependent clinical characteristics: pre-menopause patient, below the age of 70, with positive estrogen and progesterone receptors, tumor size between 1 and 2 centimeters, grade 1 or 2, and human epidermal growth factor receptor (HER) negative. For this group estimated outcomes are calculated for:

I) patients treated solely with endocrine treatment;

ii) patients treated with endocrine as well as chemotherapy; and

iii) patients who received no therapy at all, presumably indicating deviation from guidelines.

Each estimated outcome is calculated according to the distribution of actual outcomes in response to the treatment option they receive (or did not receive).

Now the distribution of outcomes within each of these three groups is estimated, for example as described above.

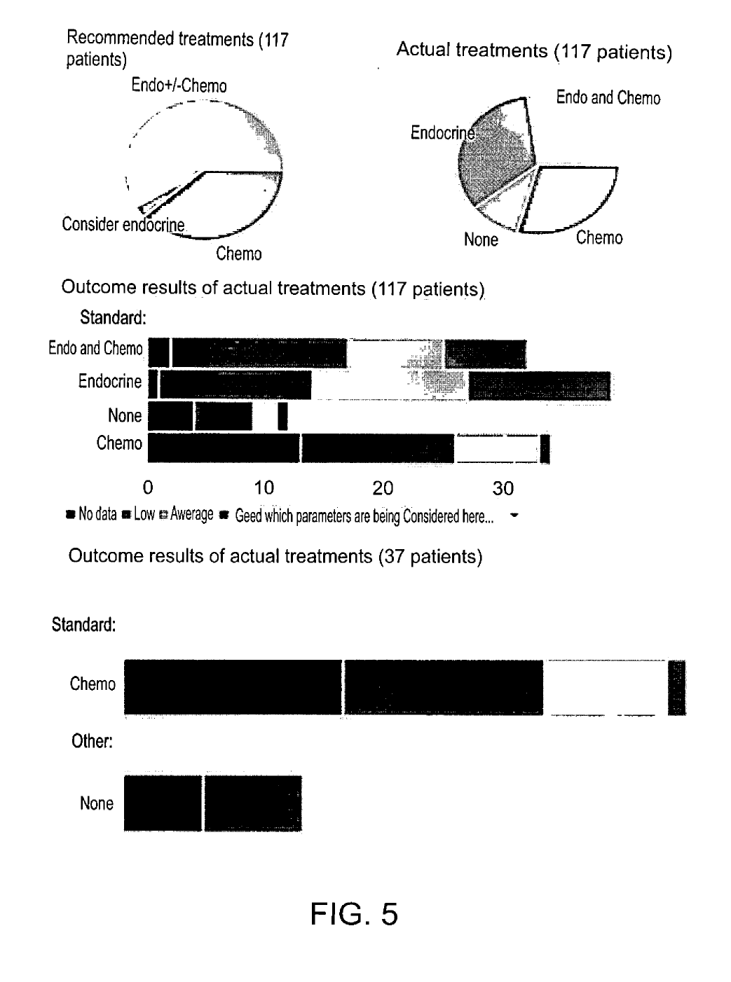

As shown at 106, the above allows generating evidence based case object 211 which outputs an evidence based case object 211 which receives patient data having a subset of patient dependent clinical characteristics and outputs an estimated prognosis under one of possible alternative treatments for the patient at the medical decision point based on the estimated outcomes of a patient group which includes patients with a similar subset of patient dependent clinical characteristics. Optionally, the evidence based case object 211 includes the above decision point model, enhanced with data extracted from the medical records databases, for example with data indicative of estimated achieved outcomes of certain treatment options. This analysis may lead to an improved patient outcome by refining guideline recommendations for patients with specific clinical characteristics, by monitoring noncompliant situations, and by revealing reasons for noncompliant successes. Optionally, the evidence based case object 211 outputs a report summarizing some of the data available in the decision point model and/or a relative estimated efficacy of optionally treatment outputs, and/or a distribution of actual treatment given to patient with similar clinical characteristics at the medical decision point, for example as shown at FIG. 5.

In such embodiments, the evidence based case object 211 provides, at a point of care, when time may be limited, recommendations from a number of different guidelines and information regarding similar patients based on the treatments they got and the outcome of their treatment (namely, integration for summarization).

As described above, the system 200 includes a KM module 201. The KM module 201 optionally includes the user interface 207 that allows an operator to reflect and manage a knowledge base, optionally separately from data-driven components of the system 200. At the same time, these data-driven components are expected to be guided and enriched by the KM module 201, through loosely coupled interfaces.

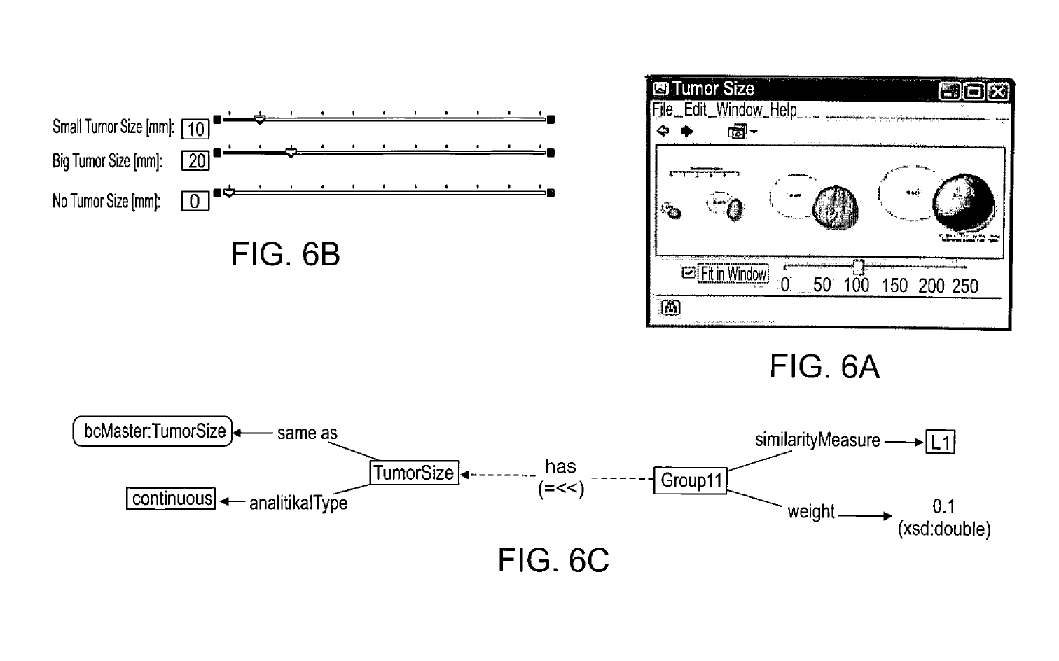

According to some embodiments of the present invention, the above method 100 is semi automatic, allowing a clinical domain expert to adjust and/or define the evidence based case object 211 using an authoring tool, for example patient dependent clinical characteristic maps. This tool should allow the clinical domain expert to reflect her personal view, based on her personal experience, a care delivery organization (CDO) and/or selected declarative knowledge which reflect general public guidelines and/or medical literature. The domain expert may start by a decision point model by constructing a relatively basic declarative-knowledge decision point model for the selected decision point which gradually enriched over time. Optionally, a declarative decision point model is generated to allow the expert clinician to use a rule-authoring environment to complete it with a procedural decision point model that enables the definition and use of patient dependent clinical characteristics. Optionally, the decision point model may be updated by a plurality of experts, optionally associated with different disciplines. Optionally, different experts from different disciplines interface with the evidence based case object 211 using distinct interfaces which are adapted to different knowledge decision point models. As a simple example, the physician may define a patient dependent clinical characteristic Tumor Size, for example using a designated user interface as shown in FIGS. 6A-6C which depict a domain expert user interface, a data integration user interface, and an analytics user interface. Optionally, the clinical domain expert is expected to give an initial representation of a patient dependent clinical characteristic, along with its relations to other patient dependent clinical characteristic and/or clinical decisions, for example whether tumor size affects a decision to give a certain treatment.

Optionally, the KM module 201 includes a user interface that allows a data integration expert that adds, through her perspective, attributes like the relevant numeric type (e.g., float), measurement units (e g millimeter or centimeters) that can be used for normalization purposes and/or a range of allowed values (e.g., from 0 to 10,000) that can be used for cleansing purposes and so forth.

Optionally, the KM module 201 includes a user interface that allows an analytics expert to add through her perspective an analytical type of the patient dependent clinical characteristic (e.g., tumor size should be represented as a continuous variable rather than categorical or ordinal), a quantitative weight, indicating an importance of this patient dependent clinical characteristic per each prediction task that a relevant for the respective decision point and/or the like.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the term a processor, a module, a database, and a platform is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and ^{the} include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6 , from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of generating evidence based case object for a decision support application, comprising:
providing a medical decision point;
generating a decision point model mapping between a plurality of patient dependent clinical characteristics and a plurality of treatment options for said medical decision point according to a plurality of guidelines for said medical decision point;
estimating, using a processor, a plurality of treatment outcomes for each said treatment option, each said treatment outcome being estimated according to an analysis of medical records of a group of patients been at said medical decision point and having a subset of said plurality of patient dependent clinical characteristics from a plurality of subsets; and
generating evidence based case object which receives patient data having patient dependent clinical characteristics matching one of said plurality of subsets and outputs an estimated prognosis for said patient at said medical decision point based on a respective treatment outcome from said plurality of treatment outcomes.

2. The method of claim 1, wherein said estimating comprises:
selecting a plurality of patient records of a plurality of patients been at said medical decision point from at least one medical records database;
dividing said plurality of patient records to said plurality of patient groups, each said group is selected according to a match with one of said plurality of subsets;
calculating, for each said patient group, a plurality of estimated treatment outcomes each for another of said plurality of treatment options.

3. The method of claim 2, wherein said calculating is performed according to a statistical analysis.

4. The method of claim 1, wherein said plurality of guidelines are automatically extracted from at least one medical knowledge database.

5. The method of claim 1, further comprising selecting at least one of said plurality of guidelines according to a user input.

6. The method of claim 1, wherein said plurality of patient dependent clinical characteristics are hierarchically arranged in said decision point model.

7. The method of claim 1, wherein said plurality of patient dependent clinical characteristics comprises a plurality of members selected from a group consisting of: a demographic characteristic, a phenotypic characteristic, a pathologic characteristic, a treatment history characteristic, and a genotypic characteristic.

8. The method of claim 1, wherein said plurality of treatment options comprises a lack of therapy option.

9. The method of claim 1, wherein said plurality of treatment options comprises incompliance with said plurality of guidelines.

10. The method of claim 1, wherein said plurality of treatment options comprises a non compliance with least one lack of therapy option.

11. The method of claim 1, further comprising allowing at least one user to add treatment options to said plurality of treatment options.

12. The method of claim 1, further comprising allowing at least one user to adjust at least one of said plurality of treatment options and said plurality of said patient dependent clinical characteristics.

13. The method of claim 1, wherein each said treatment outcome is an estimate indicative of an efficacy of a respective said treatment option to a patient having a respective said subset.

14. The method of claim 1, wherein said evidence based case object is adapted to be used by a plurality of decision support applications installed in a plurality of client terminals.

15. A computer program product for generating evidence based case object for a decision support application, comprising:
a computer readable storage medium;
first program instructions to provide a medical decision point;
second program instructions to generate a decision point model mapping between a plurality of patient dependent clinical characteristics and a plurality of treatment options for said medical decision point according to a plurality of guidelines extracted from at least one medical knowledge database;
third program instructions to generate a decision point model mapping between a plurality of patient dependent clinical characteristics and a plurality of treatment options for said medical decision point according to a plurality of guidelines extracted from at least one medical knowledge database; and
fourth program instructions to estimate a plurality of treatment outcomes for each said treatment option, each said treatment outcome being estimated according to an analysis of medical records of a group of patients been at said medical decision point and having a subset of said plurality of patient dependent clinical characteristics selected from a plurality of subsets; and
fifth program instructions to generate an evidence based case object which receive patient data having patient dependent clinical characteristics matching one of said plurality of subsets and outputs an estimated prognosis for said patient at said medical decision point based on a respective treatment outcome from said plurality of treatment outcomes;
wherein said first, second, third and fourth program instructions are stored on said computer readable storage medium.

16. An evidence based case object for a decision support application, comprising:
an input interface which receives a set of patient dependent clinical characteristics of a certain patient selected from a plurality of patient dependent clinical characteristics;
a decision point model mapping between said plurality of patient dependent clinical characteristics and a plurality of treatment options for a medical decision point, each said treatment option being associated with at least one estimated outcome for a patient having a subset of said plurality of patient dependent clinical characteristics; and
an output interface which outputs an estimated prognosis for said patient at said medical decision point based on respective said decision point model.

17. The evidence based case object of claim 16, wherein said evidence based case object is adapted to be used by a plurality of different decision support applications.

18. A system of generating evidence based case object for a decision support application, comprising:
a processor;
an interface which receives a medical decision point;
a mapping module which generates a decision point model mapping between a plurality of patient dependent clinical characteristics and a plurality of treatment options for said medical decision point according to guidelines extracted from at least one medical knowledge database;
an output module which generates an evidence based case object which receive patient data having a subset of said patient dependent clinical characteristics and outputs an estimated prognosis for said patient at said medical decision point;
wherein said mapping module estimates, using a processor, a plurality of treatment outcomes for each said treatment option, each said treatment outcome being estimated according to an analysis of medical records of a group of patients been at said medical decision point and having a subset of said plurality of patient dependent clinical characteristics selected from a plurality of subsets;
wherein said output module generates said evidence based case based on respective of said plurality of treatment outcomes.

19. The system of claim 18, further comprising a data integration module which selects a plurality of patient records of a plurality of patients been at said medical decision point from at least one medical records database, each said patient record defines which of said plurality of treatment options have been provided to a respective said patient and an outcome of said provided treatment option.

20. The system of claim 19, wherein said mapping module divides said plurality of patient records to a plurality of patient groups according to a match with said plurality of clinical characteristics and calculates, using said processor, for each said patient group, a plurality of estimated outcomes each for another of said plurality of treatment options.

21. The system of claim 18, further comprising at least one user interface set for allowing a user to adjust said decision point model.
